(19) United States
(12) Patent Application Publication
(10) Pub. No.: US 2019/0386431 A1
(43) Pub. Date: Dec. 19, 2019

(54) CONNECTOR CONNECTION STRUCTURE AND DEVICE COMPOSITE

(71) Applicants: Yazaki Corporation, Tokyo (JP); AISIN AW CO., LTD., Aichi-ken (JP)

(72) Inventors: Akira Sato, Shizuoka (JP); Akihiro Tsuruta, Shizuoka (JP); Akihiro Yamada, Aichi-ken (JP); Riku Kambe, Aichi-ken (JP)

(21) Appl. No.: 16/417,581

(22) Filed: May 20, 2019

(30) Foreign Application Priority Data
Jun. 19, 2018 (JP) 2018-116059

(51) Int. Cl. H01R 13/631; B60R 16/03; B60R 16/023

(52) U.S. Cl. CPC H01R 13/631; H01R 12/716; B60R 16/0231; B60R 16/03

(57) ABSTRACT

Provided is a connection structure and a device composite capable of suppressing terminal wrench while suppressing increase in size and assembly cost. The connector connection structure 1 includes an AT connector (first connector), and an ECU connector (second connector), the ECU side housing (second housing) is provided with a protrusion extending in a connector connection direction, that is, the direction of the terminal connection of a female type terminal (first terminal) and a male type terminal (second terminal), entering the AT side housing (first housing) prior to terminal connection, the AT side housing (first housing) is provided with a guide recess for guiding the terminal connection by entering of the protrusion.

### BACKGROUND OF THE INVENTION

### Field of the Invention

The present invention relates to a connector connecting structure for electrically connecting two devices, and a device composite in which two devices are connected via such connector connection structure.

### Description of the Related Art

Conventionally, most of automatic transmissions of a vehicle are electrically connected to a control device or the like via some type of connector connection structure (see, for example, Patent Literature 1).

In the connector connecting structure disclosed in Patent Literature 1, a connector to be fixed to a case of an automatic transmission and a connector to be fixed to a control device are connected to each other. In this case, when two connectors are connected and one connector tilts obliquely with respect to the other connector, a male type terminal would be inserted into a female type terminal and the terminal would be damaged. For this reason, it is necessary to connect the connector carefully to prevent the one connector from tilting with respect to the other connector, adding worker's burden depending on the shape of the device or the connector.

Therefore, as one method for suppressing such terminal wrench and reducing the worker's burden, for example, an edge of the housing of one connector is extended to a mating connector beyond the terminal tip to form a long hood, and the like. According to this, the mating connector will first enter the long hood, after that, the connections between the terminals is guided along the long hood, enabling to suppress terminal wrench.

It will be taken as another method of suppressing terminal wrench that for example, using a guide shaft as a jig for guiding the connection of two connectors, connectors are configured to be connected along this guide shaft. According to this, the connection between the terminals is also performed along the guide shaft, whereby the terminal wrench can be suppressed.

### CITATION LIST

### Patent Literature

### Patent Literature 1: Japanese Patent Application Laid-Open No. 2002-174331

### SUMMARY OF THE INVENTION

### Technical Problem

However, with the method of providing the long hood, the size of the connector tends to be large, that is, the connector connection structure tends to increase in size, and there is room for improvement in terms of size. Also, in the method using a guide shaft for connection of connector, it is necessary to manufacture such guide shaft, and there is room for improvement in terms of assembly cost.

Note that the connector connection structure for electrically connecting the automatic transmission and the control device has been taken as an example so far, and the circumstances that there is room for improvement is explained. However, such matters are not limited to the connector connection structure in the connection between the automatic transmission and the control device, and can generally occur in a connector connection structure for electrically connecting two devices.

Accordingly, the present invention focuses on the room for improvement as described above, and aims at providing a connector connection structure and a device composite capable of suppressing terminal wrench while suppressing increase in size and assembly cost.

### Solution to Problem

In order to solve the above-mentioned problems, a connector connecting structure of the present invention includes: a first connector in which a first terminal is accommodated in a first housing to be fixed to a first device case; and a second connector in which a second terminal connectable to the first terminal in a predetermined direction is accommodated in a second housing fittable in the predetermined direction to the first housing and to be fixed to a second device case, the second housing being fitted to the first housing, the second terminal being connected to the first terminal, and the second connector being therefore connected to the first connector, the second housing is provided with a protrusion extending in the predetermined direction and to enter the first housing in advance of a terminal connection of the first terminal and the second terminal, and the first housing is provided with a guide recess for guiding the terminal connection by allowing the protrusion to enter.

Further, in order to solve the above-mentioned problems, the device composite of the present invention includes a first device in which a first housing of a first connector is fixed to a first device housing, the first connector making a first terminal accommodated in the first housing; and a second device in which a second housing is fixed to a second device case of a second connector, a second terminal fittable in a predetermined direction to the first terminal being accommodated in the second housing fittable in the predetermined direction to the first housing, the second housing being fitted to the first housing, the second terminal being connected to the first terminal, and the second connector being therefore connected to the first connector, and the first device and the second device are electrically connected to each other by the connector connecting structure of the present invention aforementioned.

### Advantageous Effects of the Invention

According to the connector connecting structure and the device composite of the present invention, prior to terminal connection of the first connector and the second terminal of the second connector, the aforementioned protrusion enters into the guide recess, the subsequent terminal connection is guided. This guidance suppresses terminal wrench. At this time, as the protrusion is placed in the guide recess when the terminal connection is completed, so that there is little influence on the size in the connection structure. Then, since other structural parts in the first connector and the second connector are not positively used for suppressing terminal wrench, they can be adequately miniaturized. That is, according to the connector connecting structure of the present invention, the increase in size due to suppression of pinching is reduced. Further, according to the connector connecting structure of the present invention, in addition to the protrusion and the guide recess, a jig or the like for suppressing terminal wrench is unnecessary. As a result, assembly cost due to suppression of terminal wrench is reduced. As described above, according to the connector connecting structure of the present invention, it is possible to suppress the terminal wrench while suppressing the increase in size and the assembly cost.

### BRIEF DESCRIPTION OF THE DRAWINGS

FIG. 1 is a schematic diagram showing an AT/ECU composite according to an embodiment of a device composite of the present invention;

FIG. 2 is an exploded perspective view showing the connector connecting structure shown in FIG. 1;

FIG. 3 is a cross-sectional view of the AT connector shown in FIG. 2 taken along line V11-V11 in FIG. 2;

FIG. 4 is a cross-sectional view of the ECU connector shown in FIG. 2 taken along the line V12-V12 in FIG. 2;

FIG. 5 is a cross-sectional view showing that the ECU connector is connected to the AT connector obliquely inclined in the connector connecting structure shown in FIGS. 1 to 3,

FIG. 6 shows a state showing processing of the connector connection while being corrected in a connection direction which is expected as the connection direction when the ECU connector is connected to the AT connector obliquely inclined as shown in FIG. 5;

FIG. 7 shows a state showing processing of the connector connection after the state shown in FIG. 6 until the connection is finally completed; and

FIG. 8 is a comparative example for the connector connection structure shown in FIGS. 1 to 7 via the cross-sectional view similar to FIGS. 5 to 7.

### DETAILED DESCRIPTION OF THE PREFERRED EMBODIMENTS

Hereinafter, an embodiment of the present invention will be described.

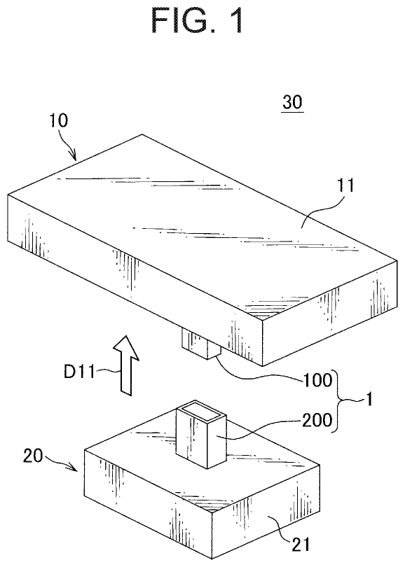

FIG. 1 is a schematic view showing an AT/ECU composite according to one embodiment of the device composite of the present invention.

The AT/ECU composite 30 includes an automatic transmission (AT) 10 (first device), ECU (Engine control Unit) 20 (second device) for controlling the AT 10. The AT 10 is the one where lubricating oil of the transmission is sealed inside the AT case 11 (first device case) along with internal devices such as a transmission and various sensors. The AT 10 and the ECU 20 are electrically connected to each other by the connecting structure 1. The connector connection structure 1 includes an AT connector 100 (first connector) and an ECU connector 200 (second connector). The AT connector 100 is fixed to an AT case 11, and the ECU connector 200 is fixed to an ECU case 21 (second device case) and is connected to the AT connector 100. In this embodiment, the ECU connector 200 is approached to the AT case 11 entirely with the ECU case 21 fixed to this ECU connector 200 in a connection direction D11 (predetermined direction) in the drawing, and is connected to the AT connection 100. This connection is configured to be detachable.

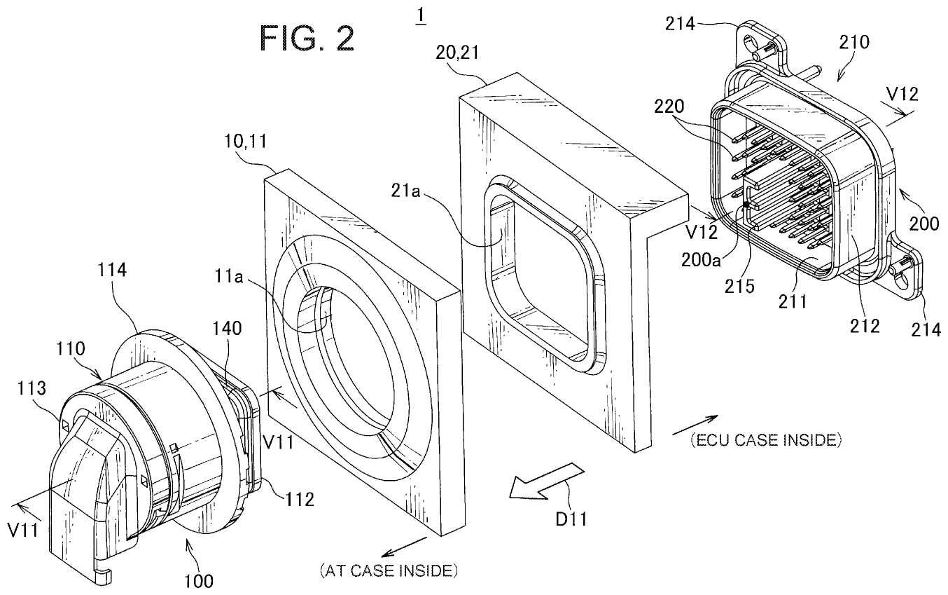

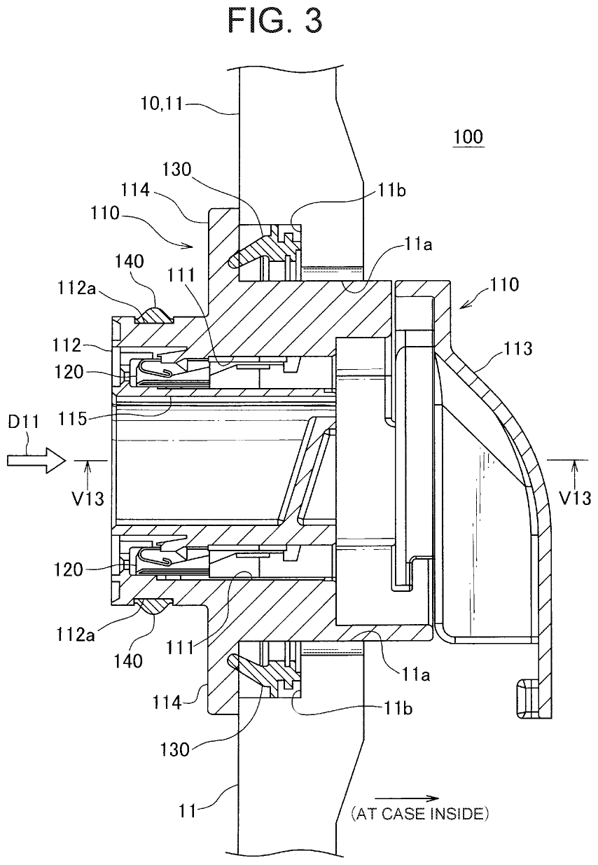

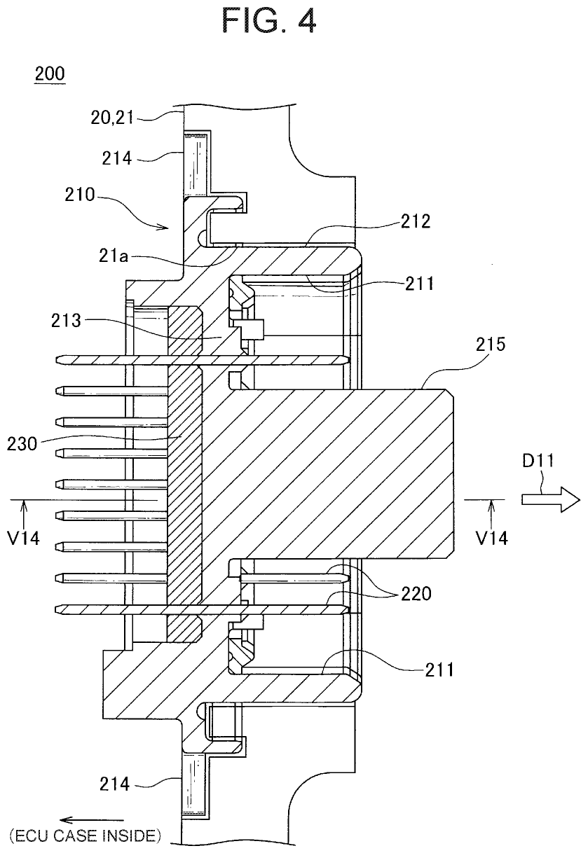

FIG. 2 is an exploded perspective view showing the connector connecting structure shown in FIG. 1. FIG. 3 is a cross-sectional view taken along the line V11-V11 in FIG. 2 in the AT connector shown in FIG. 2. FIG. 4 is a cross-sectional view of the ECU connector shown in FIG. 2, taken along the line V12-V12 in FIG. 2.

The AT connector 100 is provided at an end portion of the electric wire coming from an internal device of the AT case 11 and is also fixed to the AT case 11. An opening 11a is provided in the AT case 11, the AT connector 100 is fixed to block the opening 11a. On the other hand, the ECU connector 200 is connected to a circuit board built in the ECU 20, and is fixed to the ECU case 21 of the ECU 20. An opening 21a is also provided in the ECU case 21, and the ECU connector 200 is fixed to block the opening 21a.

Here, in the exploded perspective view of the connector connecting structure 1 of FIG. 2, in order to make the figure easy to see, the AT connector 100 is shown such that the AT connector 100 is inserted into and attached to the opening 11a from the inside of the AT case 11. However, in practice, as shown in FIG. 3, the AT connector 100 is inserted into and attached to the opening 11a from the outside of the AT case 11. The AT connector 100 is provided with a fixing flange 114 for fixing the AT connector 100 to the AT case 11. In attaching the AT connector 100, this fixing flange 114 is inserted into the opening 11a from the outside of the AT case 11 and mounted so that the AT connector 100 abuts on the outer surface around the opening 11a in the case 11. On the other hand, the ECU connector 200, as shown in both FIG. 2 and FIG. 4, is inserted into the opening 21a from the inside of the ECU case 21.

The AT connector 100 is a female type connector in which a plurality of female type terminals 120 (first terminals) each crimped to an end of an electric wire (not shown) is accommodated in a plurality of terminal accommodating chambers 111 provided in an AT-side housing 110 (first housing) fixed to the AT case 11 of the AT 100. The AT side housing 110 is provided with a projection 112 to be a portion which enters the ECU connector 200 in the AT connector 100. On the end surface on the ECU connector 200 at the projection 112, a terminal insertion port for the female type terminal 120 is open, communicating with the terminal receiving chamber 111.

In addition, the AT side housing 110 is provided with the fixing flange 114 for fixing the AT connector 100 to the AT case 11 with the projection 112 protruding from the AT case 11 to outside and the other part 113 entering the AT case 11. And, the AT connector 100 is inserted into the opening 11a from the outside of the AT case 11 and the fixing flange 114 is fixed in contact with the periphery of the opening 11a.

The ECU connector 200 is a male type connector in which a plurality of male type terminals 220 (second housing) each of which is pin-like shaped and is connectable to the female type terminal 120 in the connection direction D11 is accommodated in the ECU side housing 210. The ECU side housing 210 is fixed to the ECU case 21 that can be fitted in the connecting direction D11 with respect to the AT side housing 110. The ECU side housing 210 is provided with a recess 211 for receiving the projection 112 of the AT connector 100. A pin-shaped male type terminal 220 is attached penetrating through a bottom wall 213 of the recess 211. The side opposite to the AT connector 100 in the male type terminal 220 is soldered to a circuit board (not shown) inside the ECU 20. When the projection 112 of the AT connector 100 enters the recess 211 of the ECU connector 200, the male type terminal 220 enters from the terminal insertion port of the end face of the projection 112 and is connected to the female type terminal 120.

The ECU side housing 210 is provided with a fixing flange 214 for fixing the ECU connector 200 to the ECU case 21 with a bottomed tubular portion 21 that abuts on a hood provided with the recess 211 being fitted inside the opening 21a. Then, the ECU connector 200 is inserted into the opening 21a from the inside of the ECU case 21 such that the fixing flange 214 abuts on the periphery of the case inner surface side of the opening 21a, and the fixing flange 214 is fixed to the periphery.

Further, in the connector connecting structure 1 of the present embodiment, a first sealing member 130 and a second sealing member 230 to be described below are provided in order to prevent oil leakage from the AT case 11.

The first sealing member 130 is a gasket made of resin for sealing a space between the AT connector 100 and the AT case 11. This first sealing member 130 is formed in a ring shape and attached so as to surround the outer peripheral surface of the AT side housing 110 at a position closer to the inside of the AT case 11 than the fixing flange 114 in the AT side housing of the AT connector 100. When the AT connector 100 is inserted into the opening 11a from the outside and the fixing flange 114 is fixed to the outer surface of the AT case 11, the first sealing member 13 is, while adhering to each of a step portion 11b and the fixing flange 114, sandwiched by both of them. And thereby, the first sealing member 130 seals the space between the AT connector 100 and the AT case 11. Then, this sealing member 130 prevents oil leakage from between AT connector 100 and AT case 11.

The second sealing member 230 is a resin filler that seals a space between the ECU side housing 210 and the male type terminal 220 in the ECU connector 200. The second sealing member 230 is filled on the side opposite to the AT connector 100 in the bottom wall 213 that receives the projection 112 of the AT connector 100 in the side housing 210. As a result, the second seal 230 seals the space between the ECU side housing 210 and the male type terminal 220. The second sealing member 230 prevents oil leakage passing from the inside of the AT case 11 through the female type terminal 120 into the ECU case 21 and the male type terminal 220 in the ECU connector 200.

Furthermore, in the present embodiment, a third sealing member 140 is provided so as to surround the outer peripheral surface of the projection 112 of the AT side housing 110 of the AT connector 100. The third sealing member 140 is a packing formed in a ring-shaped ring and made of resin for sealing a space between the AT connector 100 and the ECU connector 200.

The outer peripheral surface of the above-mentioned projection 112 is provided with a recessed groove 112a around the periphery in the peripheral direction, in which the third sealing member 140 formed in a ring shape is fitted. When the projection 112 of the AT connector 100 enters the recess 211 of the ECU connector 200, the third sealing member 140, while adhering closely to the outer peripheral surface of the projection 112 and the inner peripheral surface of the recess 211, is sandwiched therebetween. As a result, the third sealing member 140 hermetically seals the space between the AT connector 100 and the ECU connector 200. Then, the third sealing member 140 prevents a liquid such as water coming from the outside of the AT case 11 and the ECU case 21 along a space therebetween from entering into the AT case 11 and the ECU case 21.

Here, in the connector connecting structure 1 of the present embodiment, the following guide structure is provided for guiding the terminal connection between the female type terminal 120 of the AT connector 100 and the male type terminal 220 of the ECU connector 200. That is, a protrusion 215 is provided in the ECU side housing 210, and a guide recess 115 is provided in the AT side housing 110.

The protrusion 215 has its tip extend projecting in the connector connection direction, that is, in the connection direction D11 of the terminal connection, beyond an end of the bottomed cylindrical portion 212 of the ECU side housing 210 and the male type terminal 220. As a result, the protrusion 215 enters the AT side housing 110, prior to the terminal connection by insertion of the male type terminal 220 into the female type terminal 220. Further, because the protrusion 215 protrudes beyond the end of the bottomed cylindrical portion 212, the protrusion 215 also enters the guide recess 115 prior to the fitting of the AT side housing 110 and the ECU side housing 210.

Further, as shown in FIG. 2, the protrusion 215 is disposed at the center of the bottomed tubular portion 212 in a plan view viewed from the side of connection with the AT connector 100. Then, in this plan view, the protrusion 215 is formed in an E shape which is astigmatic symmetry with respect to the center point 200a in the ECU connector 200. Multiple male type terminals 220 are arranged avoiding the protrusion 215. The center point 200a mentioned here is a geometric center with respect to the contour shape of the ECU connector 200 in the aforementioned plan view.

It should be noted that the astigmatic symmetrical shape of the protrusion 215 is not limited to the E shape, but may be other shapes, for example, an F shape as long as they are astigmatic.

On the other hand, the guide recess 115, which is a portion guiding the housing fitting and the terminal connection by entering of the protrusion 215, is provided on the projection 112 in the AT side housing 110. This guide recess 115 is disposed at the center of the projection 112 in plan view when the projection 112 is viewed from the side of connection with the ECU connector 200. Then, the guide recess 115 has an E shape to be fitted to the protrusion 215 in this plan view. The plurality of the terminal accommodating chambers 111 is arranged on the projection 112 avoiding the guide recess 115.

In the connector connecting structure 1 of the present embodiment, terminal wrench is suppressed by the protrusion 215 and the guide recess 115 for guiding the terminal connection between the AT connector 100 and the ECU connector 200 as the guide structure. Terminal pinching as used here refers to a pinching insertion of the male type terminal into the female type terminal connected with each other, which occurs when one of the connectors is connected obliquely to the other connector at an angle.

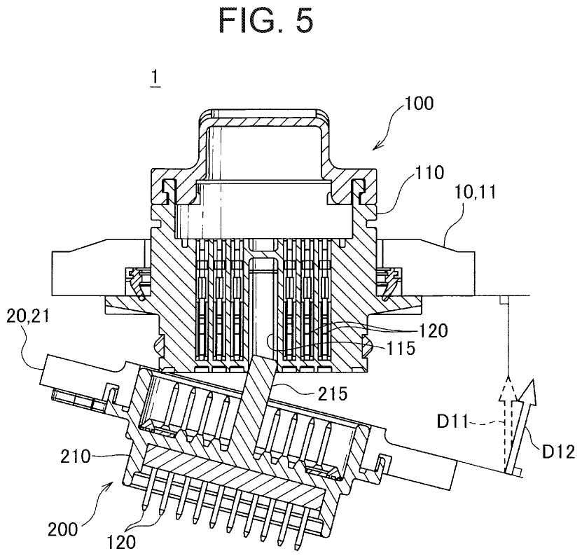

FIG. 5 is a view showing a state the ECU connector in the connector connecting structure shown in FIGS. 1 to 3 is inclined obliquely with respect to the AT connector and is being connected thereto. In FIG. 5 and FIGS. 6 and 7 to be mentioned later the AT connector 100 in the connector connection structure 1 is shown with cross-section along V13-V13 in FIG. 3, the ECU connector 200 with cross-section along V14-V14 in FIG. 4.

In connection work of the AT/ECU composite 30 shown in FIG. 1, connection starts, as shown in FIG. 5, in a state in which the connection direction D12 is inclined obliquely from the connection direction D11 which should be originally intended. In the present embodiment, the ECU connector 200 is connected to the AT connector 100 with the entire of the ECU case 21 of the ECU 20 being brought close to the AT case 11 of the AT 10. Therefore, at the time of the connection work, the ECU connector 200 is hidden, and hard to see, by the ECU case 21 from the worker, and as shown in FIG. 5, while the connection direction D12 is obliquely inclined, the ECU connector 200 may be connected in some cases. Assume that this oblique connection direction D12 has progressed without correcting D12 to the connection direction D11 to be expected. Then, the ECU side housing 210 and the AT side housing 110 are fitted in an oblique state, and the male type terminal 220 is subsequently inserted into the female type terminal 120 in an obliquely inserted manner, which may cause a danger of terminal wrench.

However, in this embodiment, the protrusion 215 provided in the ECU connector 200 in such a case, reaching the AT connector 100 prior to the housing fitting and the terminal connection, interferes with the opening edge of the guide recess 115 provided in the AT connector 100. Because of this interference, circumstances are avoided that terminal wrench occurs where the ECU connector 200 is connected in the oblique connection direction D12.

Thereafter, the ECU connector 200 is guided by the protrusion 215 and the guide recess 115, and while being corrected to follow the connection direction D11, moves forward to the AT connector 100.

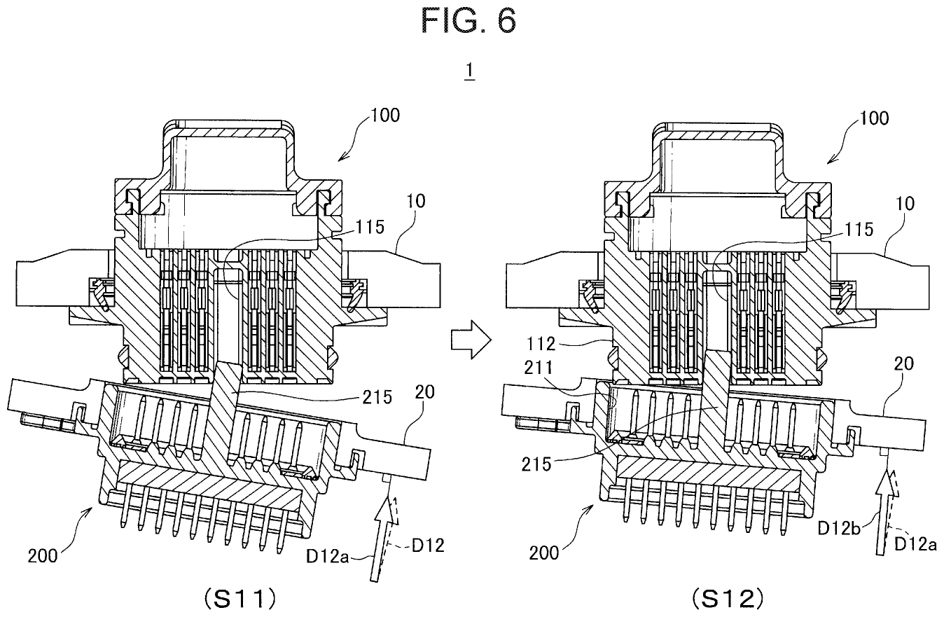

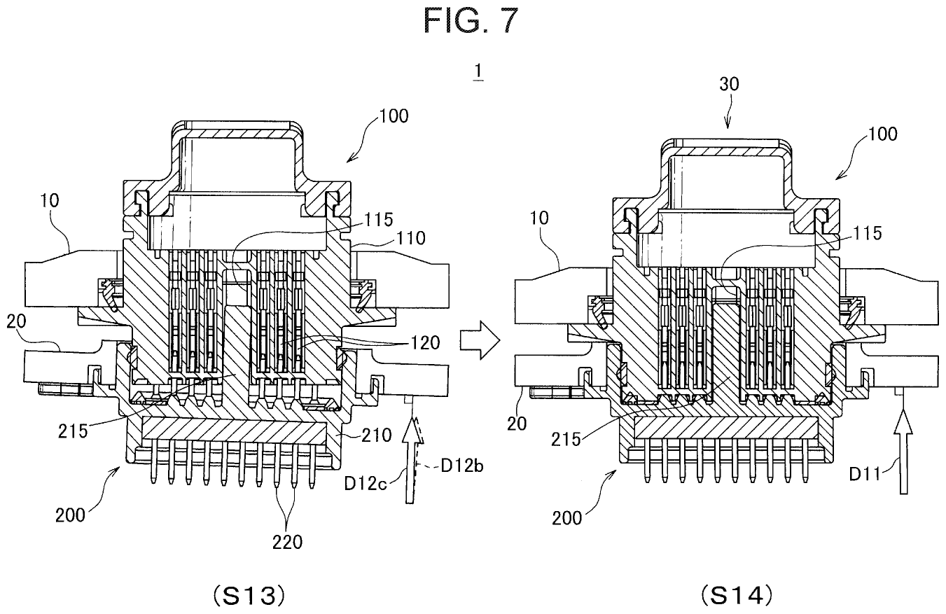

FIG. 6 shows a state in which when the ECU connector is inclined to the AT connector as shown in FIG. 5, the connection direction is corrected to the connection direction to be expected, while the connector connection moves forward. Further, FIG. 7 shows a state after the state shown in FIG. 6 and finally how the connector connection progresses until the connection is completed.

In step S11 of FIG. 6, the protrusion 215 of the ECU connector 200 in the connector connection structure 1 slightly advances into the guide recess 115 of the AT connector 100. That approach allows the inclined connection direction D12a of the ECU connector 200 shown also in FIG. 5 to be slightly corrected from the direction D12 toward the connecting direction D11 to be expected. In Step 12, the ECU connector 200 enters until the projection 112 of the AT connector 100 contacts the edge of the recess 211 of the ECU connector 200, and the protrusion 215 further enters inside the guide recess 115 of the AT connector 100. As a result, the connection direction D12b of the ECU connector 200 is further corrected from the connection direction D12a in step S11.

In step S13 of FIG. 7, an engagement of the ECU side housing 210 and the AT side housing 110 is advancing to some extent in the connector connecting structure 1. The ECU connector 200 enters until the male tape terminal 220 of the ECU connector 200 is slightly inserted into the female type terminal 120 of the AT connector 100, and the protrusion 215 further enters inside the guide recess 115. At this stage, the connection direction D12c of the ECU connector 200 becomes a state of further being corrected from the direction D12b in step S11 until the pinching insertion of the male type terminal 220 into the female type terminal 120 is sufficiently suppressed. After that also, correction in the connection direction of the ECU connector 200 proceeds, and is completed until it coincides with the connection direction D11 which should be substantially expected by the time the ECU connector 200 is connected to the AT connector 100 in step S14. In this state the protrusion 215 of the ECU connector 200 is substantially within the inside of the guide recess 115 of the AT connector 100. The connection of the ECU 20 to the AT 10 is completed in this step S14, and thus the AT/ECU composite 30 shown in FIG. 1 is completed.

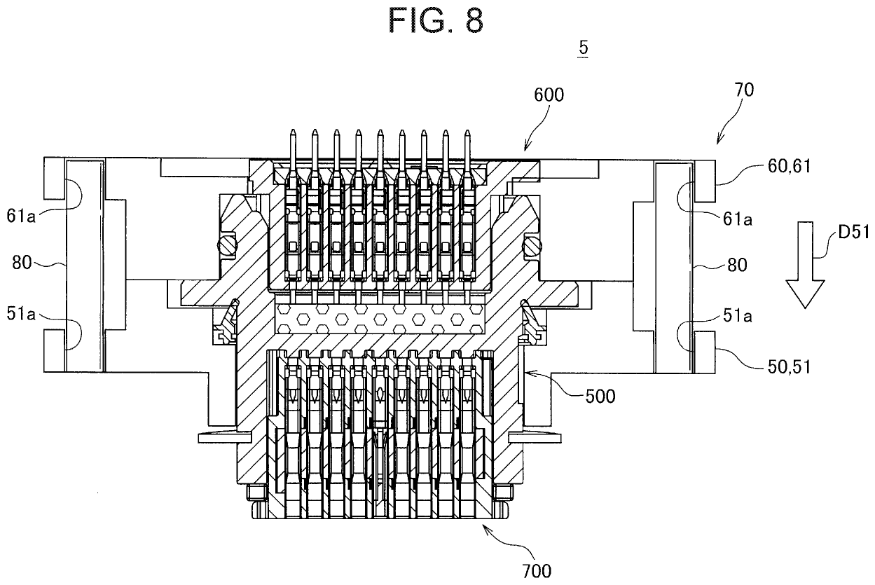

FIG. 8 is a view showing a comparative example for the connector connection structure shown in FIGS. 1 to 7 via cross-sectional view similar to FIGS. 5 to 7.

First, in FIG. 8, contrary to FIG. 1 and FIGS. 5 to 7, an AT 50 is shown on the lower side in the figure, and an ECU 60 is shown on the upper side. And, in the comparative example connector connection structure 5 shown in FIG. 8, an ECU connector 600 fixed to an ECU case 61 is connected to a relay connector 500 fixed to an AT case 51. An AT connector 700 is connected to the relay connector 500 in the inside of the AT case 51, so that an AT/ECU composite 70 is constituted.

Here, in the connector connecting structure 5 of the comparative example, the connector connection is guided by adapting the following guiding structure in order to suppress terminal wrench in the terminal connection between the ECU connector 600 and the relay connector 500. That is, in the connector connecting structure 5 of the comparative example a plurality of guide shafts 80 is used as jig for guiding the connector connection. Each guide shaft 80, one end thereof is, prior to the connector connection, attached to an attachment hole 51a provided in the AT case 51, and is erected on the AT case 51 so as to extend along the connecting direction D51 of the ECU connector 600 to be expected.

The ECU case 61 is provided with a through hole 61a at a position opposed in one-to-one to the attachment hole 51a of the AT case 51. When connecting the connector, the ECU connector 600 is slid toward the relay connector 500 fixed to the AT case 51 with the guide shaft 80 being passed through the through hole 61a of the ECU case 61. The movement of the ECU connector 600 is guided by the guide shaft 80 together with the ECU case 61, so that the ECU connector 600 is connected to the relay connector 500 in the connection direction D 51 to be expected. Guiding of the guide shaft 80 like this suppresses terminal wrench in the terminal connection. The guide shaft 80 is removed after completion of the connector connection.

However, in the connector connecting structure 5 of the comparative example using the guide shaft 80 for connector connection, such production of the guide shaft 80 and processing of the AT case 51 and the ECU case 61 are required and there is room for improvement in terms of assembly cost.

On the other hand, according to the connector connecting structure 1 of the embodiment shown in FIGS. 1 to 7, prior to the terminal connection, the protrusion 215 of the ECU connector 200 is inserted into the guide recess 115 of the AT connector 100, and whereby the subsequent terminal connection is guided. This guidance suppresses terminal wrench. At this time, the protrusion 215 is accommodated in the guide recess 115 when the terminal connection is completed, and there is almost no influence on the size of the connector connection structure 1. Other structural parts of the AT connector 100 and the ECU connector 200 are not actively utilized for the size, and it is thus possible to downsize them appropriately. In addition, according to the present embodiment, the increase in the size due to suppressing the terminal wrench can be reduced. Further, according to the present embodiment, other than the protrusion 215 of the ECU connector 200 and the guide recess 115 of the AT connector 100, a jig or the like for suppressing terminal wrench is unnecessary. For this reason, assembly cost due to suppression of terminal wrench is reduced. In this manner, the connector connection structure 1 according to the present invention, while suppressing the increase in size, and the assembly cost, terminal wrench can be suppressed.

Here, in the present embodiment, other than the fitting structure of the ECU side housing 210 and the AT side housing 110, and the protrusion 215 and the guide recess 115 as a guide structure for guiding the terminal connection, no structure including a guide shaft is provided. Note that what is actively used as the guiding structure is just the protrusion 215 and the guide recess 115. The fitting structure of the ECU side housing 210 and the AT side housing 110 consequently contributes to guiding the terminal connection from the shape of each housing. In the present embodiment, since no other structure is provided besides these as the guiding structure, assembly cost due to suppression of terminal wrench can further be reduced.

Further, in the present embodiment, the protrusion 215 is destined to enter into the guide recess 115 before the fitting of the AT side housing 110 and the ECU side housing 210. This can guide not only the terminal connection but also the housing fitting which slightly proceeds.

Further, in the present embodiment, the protrusion 215 has the astigmatism symmetrical shape with the center point 200a of the ECU connector 200 in plan view when viewing the AT connector 100 from the side of connection of the ECU connector 200. Then, the guide recess 115 has the shape engaging the protrusion 215.

Assume that the ECU connector 200 is being connected in a state in the reverse direction rotating by 180° around the center point 200a in the above plan view. According to the connector connecting structure 1 of the present embodiment, the protrusion 215 has the astigmatism symmetrical shape, and the guide recess 115 has the shape fitting to the protrusion 215, the protrusion 215 cannot thus enter the guide recess 115 in the reverse state as described above. This makes it possible to avoid connector connection in the reverse direction.

Further, in the present embodiment, the ECU connector 200 is brought close to the AT case 11 together with the entire of the ECU case 21 fixed to this ECU connector 200, and is connected to the AT connector 100. Then, the protrusion 215 is provided in the ECU connector 200, and the guide recess 115 is provided in the AT connection 100.

According to the connector connecting structure 1, as described above, the protrusion 215 is provided in the ECU connector 200 which is brought close to the AT case 11 together with the ECU case 21. This allows an operator who performs connector connection to visually observe the positions of the protrusion 215 and the guide recess 115 while entering the projecting 215 into the guide recess 115 so as to work the connector connection. In the case of the opposite positional relationship, the guide recess is hidden by the ECU case, often making it difficult for the operator to see. According to the present embodiment, it is possible to visually confirm the connector connection under good workability.

Further, in the connector connecting structure 1 of the present embodiment, the protrusion 215 is provided in the ECU connector 200 that is male type connector, and the guide recess 115 is provided in the female connector AT connector that is female type connector.

According to the connector connecting structure 1, since the insertion direction of the male type terminal 220 to the female type terminal 120 and the entering direction of the protrusion 215 to the guide recess 115 coincide with each other in the same direction, the operator can perform the connector connection work with a good working feeling.

According to the AT/ECU composite 30 of the present embodiment, since the above-described connector connecting structure 1 is used for electric connection of the AT 10 and the ECU 20, it is possible to suppress terminal wrench while suppressing increase in size and assemble cost.

Further, in the AT/ECU composite 30 of the present embodiment, electrical connection between the AT 10 and the ECU 20, which is, in general, often performed by connecting connectors fixed to each device, is performed using the connector connecting structure 1 of the present embodiment. As a result, the AT 10 and the ECU 20 can be connected while suppressing terminal wrench and reducing increase in size and the assembly cost.

It is to be noted that the above-described embodiment merely shows a representative form of the present invention, and the present invention is not limited thereto. That is, various deformations within a range not deviating from the gist of the present invention can be carried out. Such deformation, as long as having the connector connecting structure or the constitution of the device composite of the present invention is of course included in the scope of the present invention.

For example, in the above-described embodiment, as an example of a connector connecting structure according to the present invention, the connector connecting structure 1 for electrically connecting the AT 10 and the ECU 20 to each other is illustrated. Further, as an example of the device composite referred to in the present invention, the AT/ECU composite 30 to which the AT 10 and the ECU 20 are connected are illustrated. However, the connector connecting structure and the device composite referred to in the invention are not limited to these. That is, specific aspect is acceptable as far as a connector connecting structure for electrically connecting two devices or a device composite where two devices are connected via the connector connecting structure.

Further, in the above-described embodiment, as an example of the connector connection structure referred to in the present invention, the connector connecting structure 1 for connecting the AT connector 100 secured to the AT case 11 and the AT connector 100 and the ECU connector 200 is exemplified. Then, as an example of the device composite body, the AT/ECU composite 30 is illustrated in which the AT 10 and the ECU 20 are connected via the connector connection structure 1. However, the connector connection structure and the device composite according to the present invention are not limited to these. That is, the connector connecting structure for example, the relay connector as shown as a comparative example in FIG. 8 may be connected to the ECU connector 200 equipped with the protrusion 215. In this case, a guide recess for receiving the protrusion 215 is formed. Then, the composite assembly referred to in the present invention may be the AT/ECU composite or the like where the AT and the ECU are connected via the connector connection structure having such relay connector.

Further, in the above-described embodiment, as an example of the connector connection structure referred to in the present invention, the connector connection structure 1 is illustrated where the protrusion 215 is provided in the ECU connector 200 on the side approaching to the mating side, and the guide recess 115 is provided in the AT connector 100 on the mating side, but the connector connecting structure according to the invention is not limited to this. The connector connecting structure referred to in the present invention may be the one in which the protrusion is provided in the AT connector of the mating side and the ECU connector on the side approaching the mating side. However, providing the protrusion 215 in the ECU connector 200, and the guide recess 115 in the AT connector 100 allows connector connection under visually favorable workability as described above.

Further, in the above-described embodiment, as an example of the connector connecting structure referred to in the present invention is illustrated where the protrusion 215 is provided in the ECU connector 200 which is male type connector, and a guide recess 115 is provided in the AT connector 100 which is female type connector. However, the connector connecting structure referred to in the present invention is not limited to this. The connection structure referred to in the present invention may be the one in which a protrusion is provided in the female connector, and a guide recess is provided in the male connector. However, providing the protrusion in the male connector and the guide recess in the female connector allows workers to work connector connection under a good working feeling as mentioned above.

### REFERENCE SIGNS LIST

1 connector connection structure
10 AT (first device)
11 AT case (first device case)
20 ECU (second device)
21 ECU case (second device case)
30 AT/ECU composite (device composite)
100 AT connector (first connector)
110 AT side housing (first housing)
115 guide recess
120 female type terminal (first terminal)
200 ECU connector (second connector)
200 center point
210 ECU side housing (second housing)
215 protrusion
220 male type terminal (second terminal)
D11, D12, D12a, D12b, D12c connection direction (predetermined direction)

What is claimed is:

1. A connector connecting structure comprising:
a first connector in which a first terminal is accommodated in a first housing to be fixed to a first device case; and
a second connector in which a second terminal connectable to the first terminal in a predetermined direction is accommodated in a second housing fittable in the predetermined direction to the first housing and to be fixed to a second device case, the second housing being fitted to the first housing, the second terminal being connected to the first terminal, and the second connector being therefore connected to the first connector, wherein
the second housing is provided with a protrusion extending in the predetermined direction and to enter the first housing in advance of a terminal connection of the first terminal and the second terminal, and wherein
the first housing is provided with a guide recess for guiding the terminal connection by allowing the protrusion to enter.

2. The connector connecting structure according to claim 1, wherein
any of the first device case, the second device case, the first connector, and the second connector has no structure, as a guiding structure guiding the terminal connection, including a guide shaft other than the fitting structure of the first housing and the second housing, the protrusion, and the guide recess.

3. The connector connecting structure according to claim 1, wherein
the protrusion enters the guide recess also in advance of fitting of the first housing and the second housing.

4. The connector connecting structure according to claim 2, wherein
the protrusion enters the guide recess also in advance of fitting of the first housing and the second housing.

5. The connector connecting structure according to claim 1, wherein
the protrusion is formed in an asymmetrical shape with respect to a center point of the second connector in plan view viewing the second connector from a connection side with the first connector.

6. The connector connecting structure according to claim 2, wherein
the protrusion is formed in an asymmetrical shape with respect to a center point of the second connector in plan view viewing the second connector from a connection side with the first connector.

7. The connector connecting structure according to claim 3, wherein
the protrusion is formed in an asymmetrical shape with respect to a center point of the second connector in plan view viewing the second connector from a connection side with the first connector.

8. The connector connecting structure according to claim 4, wherein
the protrusion is formed in an asymmetrical shape with respect to a center point of the second connector in plan view viewing the second connector from a connection side with the first connector.

9. The connector connecting structure according to claim 1, wherein
the second connector is configured such that the second device case to which the second housing is fixed is entirely approached to the first device case so as to be connected to the first connector.

10. The connector connecting structure according to claim 2, wherein
the second connector is configured such that the second device case to which the second housing is fixed is entirely approached to the first device case so as to be connected to the first connector.

11. The connector connecting structure according to claim 3, wherein
the second connector is configured such that the second device case to which the second housing is fixed is entirely approached to the first device case so as to be connected to the first connector.

12. The connector connecting structure according to claim 4, wherein
the second connector is configured such that the second device case to which the second housing is fixed is entirely approached to the first device case so as to be connected to the first connector.

13. The connector connecting structure according to claim 5, wherein
the second connector is configured such that the second device case to which the second housing is fixed is entirely approached to the first device case so as to be connected to the first connector.

14. The connector connecting structure according to claim 6, wherein
the second connector is configured such that the second device case to which the second housing is fixed is entirely approached to the first device case so as to be connected to the first connector.

15. The connector connecting structure according to claim 7, wherein
the second connector is configured such that the second device case to which the second housing is fixed is entirely approached to the first device case so as to be connected to the first connector.

16. The connector connecting structure according to claim 8, wherein
the second connector is configured such that the second device case to which the second housing is fixed is entirely approached to the first device case so as to be connected to the first connector.

17. The connector connecting structure according to claim 1, wherein
the first connector is a female type connector having a female type terminal as the first terminal, and the second connector is a male type connector having a male type terminal as the second terminal.

18. A device composite comprising:
a first device in which a first housing of a first connector is fixed to a first device housing, the first connector making a first terminal accommodated in the first housing; and
a second device in which a second housing is fixed to a second device case of a second connector, a second terminal fittable in a predetermined direction to the first terminal being accommodated in the second housing fittable in the predetermined direction to the first housing, the second housing being fitted to the first housing, the second terminal being connected to the first terminal, and the second connector being therefore connected to the first connector, wherein
the first device and the second device are electrically connected to each other by the connector connecting structure according to claim 1.

19. The device composite according to claim 18, wherein
the first device is an automatic transmission of a vehicle, and the second device is a control device for the automatic transmission.
